(19) United States
(12) Patent Application Publication
(10) Pub. No.: US 2025/0009001 A1
(43) Pub. Date: Jan. 9, 2025

(54) INFANT FORMULA CONTAINING SERUM PROTEIN CONCENTRATE

(71) Applicant: FRIESLANDCAMPINA NEDERLAND B.V., Amersfoort (NL)

(72) Inventors: Roeland Van Eerten, Houten (NL); Teartse Lambers, Nijmegen (NL); Thomas Rijswijk, Deventer (NL)

(21) Appl. No.: 18/708,559

(22) PCT Filed: Nov. 22, 2022
(86) PCT No.: PCT/EP2022/082857

§ 371 Date: May 8, 2024

(30) Foreign Application Priority Data
Nov. 23, 2021 (EP) 21210033.3

(51) Int. Cl. A23L 33/00; A23C 9/142; A23J 1/20; A23L 33/19

(52) U.S. Cl. CPC A23L 33/40; A23C 9/1422; A23J 1/20; A23L 33/19

(57) ABSTRACT

Formula milk wherein at least 90 wt % of the total amino acid content results from a serum protein concentrate, said serum protein concentrate being obtained by a process involving microfiltration of milk resulting in a casein-rich retentate and a serum-rich fraction as the permeate, followed by concentration of the serum-rich fraction.

The present invention relates to an infant formula containing serum protein concentrate.

The best nutrition supplied to an infant is generally considered to be its own mother's milk; i.e. human milk. However, situations may arise wherein the infant cannot be fed human milk. In such cases, bovine milk-based formula milk is generally used to nourish the infant. These formulas contain a mixture of casein and whey proteins to provide an amino acid profile as close as possible to that of human milk.

Unfortunately, the protein compositions of human milk and bovine milk differ substantially, both quantitatively and qualitatively. A prominent difference is the lower total protein content of human milk: the total protein content (i.e. the total nitrogen content multiplied by 6.25) of human milk is generally around 11 g/L; that of bovine milk around 33-35 g/L.

Human milk and bovine milk further differ in the type of proteins they contain.

The total nitrogen containing components in milk can be divided into true protein and non-protein nitrogen (NPN), with caseins and serum proteins (also called whey proteins) as the main classes of proteins. Caseins are the proteins that precipitate at pH 4.6, whereas whey proteins remain soluble at this pH. In human milk, the ratio of whey protein to casein varies from about 90:10 in the first days after birth to about 60:40 in mature human milk, whereas the whey protein to casein ratio is around 20:80 in bovine milk.

Also the composition of the casein and whey protein fractions differ between human and bovine milk. The most abundant whey proteins in human milk are α-lactalbumin, lactoferrin and immunoglobulins, whereas the whey protein fraction of bovine milk comprises approximately ˜50% β-lactoglobulin and ˜15% α-lactalbumin. The most abundant casein in human milk is beta-casein, whereas bovine milk comprises about 50% alpha-casein and about 35% beta-casein.

Another important difference is the relatively high content of essential amino acids in human milk. These amino acids cannot be synthesized in the human body and need to be introduced into the human body via food.

Formula milk includes infant formulas and follow-up formulas, which are able to supply the complete nutritional requirements of infants in the first months of their life up to the introduction of appropriate complementary feeding. Legal requirements exist which regulate the required ingredients in such formula milks. One of the these requirements being the minimum content of the essential amino acids and several conditionally essential amino acids as aligned with the composition of human milk. See for instance the CODEX Alimentarus or EU Commission Directive 2016/127/EC dated Sep. 25, 2015.

In order to ensure the minimum amounts of these (conditionally) essential amino acids, the protein content of conventional dairy-based formula milk is significantly higher than that of human milk.

For instance, conventional protein sources in formula milk are combinations of a milk powder or milk concentrate and demineralized whey protein concentrate; generally a demineralized cheese whey concentrate. The whey protein concentrate is added to bring the whey: casein ratio closer to that of human milk.

In order to ensure the required content of essential amino acids, the total protein content of infant formulas is generally in the range 1.8-3.0 g/100 kcal. The high end of this range has the drawback that—as shown by several studies—it causes a rapid weight gain during the first year of life, which may affect body composition later in life.

As a result, a lot of research is ongoing towards infant formulas with lower total protein content, without compromising on essential amino acid content.

Examples of ways in which this problem can be solved include the addition of free amino acids, the use of caseinoglycomacropeptide (CMP)-depleted whey, the addition of protein hydrolysates, and/or the use of α-lactalbumin enriched whey.

The present invention now provides a formula milk with serum protein concentrate (SPC) as the major, preferably the sole, amino acid source. This allows the preparation of low protein formula milk with a good essential amino acid profile and a casein/whey protein ratio close to that of human milk. The use of SPC also allows for the preparation of a formula milk with a minimum number of processing steps that can denature bioactive ingredients such as lactoferrin and immunoglobulins.

Furthermore, compared to cheese whey protein, SPC is naturally free of CMP. CMP is a cleavage product of κ-casein, which is formed during cheese making under the influence of the enzyme chymosin. CMP is rich in threonine and its oligopeptide form allows quick absorption of threonine by the body, which may lead to overdosing causing hyperthreoninemia in prematures. Furthermore, high levels of CMP negatively affect the amino acid pattern, especially the amount of essential amino acids.

SPC is furthermore high in alpha-lactalbumin and beta-casein, meaning that the overall protein composition of the claimed formulation is better aligned with the protein composition of breastmilk.

Like whey protein concentrate (WPC), serum protein concentrate (SPC) is the result of separating skimmed milk into a casein-rich and a whey protein-rich fraction, followed by a concentration step.

Whey protein concentrate (WPC) is a product obtained by ultrafiltration and/or reverse osmosis and optionally demineralization of acid whey (obtained by acidification of milk, i.e. caseinate production) or cheese whey (obtained by renneting, i.e. cheese making).

By ultrafiltration, a large part of the water, lactose and ash are removed from the product, thereby concentrating the whey proteins. Reverse osmosis can be used to remove water and to further concentrate the WPC.

The preparation of SPC, on the other hand, involves microfiltration of (skimmed) milk. Said microfiltration results in a concentrated (micellar) casein retentate and a serum fraction containing most of the whey proteins as the permeate. The serum protein fraction is also called ideal whey. Conventionally, this permeate fraction is then subjected to ultrafiltration and/or reverse osmosis in order to remove lactose, ash, and water.

As such, the use of SPC as whey protein source in formula milk is known. See for instance WO 00/30461, WO 2008/127104 A1, WO 2013/068653 A2, and WO 2020/159356 A1. However, in addition to the SPC, the prior art formula milks always contain a significant amount of at least one additional protein source, such as milk, micellar casein, or the casein-rich microfiltration retentate.

The present invention relates to a formula milk wherein at least 90 wt %, preferably at least 95 wt %, more preferably at least 99 wt %, and most preferably 100 wt % of the total amino acid content results from a serum protein concentrate.

In a preferred embodiment, the formula milk has a low protein content, of at most 2.3 g protein/100 kcal, preferably at most 2.2, more preferably at most 2.1, even more preferably at most 2.0, more preferably at most 1.9 g protein/100 kcal. The protein content of the formula milk is preferably at least 1.6 g protein/100 kcal, more preferably at least 1.7, most preferably at least 1.8 g protein/kg100 kcal.

Despite the low protein content and/or the SPC being (almost) the sole amino acid source, the concentration of essential amino acids satisfies the legal requirements. More in particular, the formula milk has the following essential amino acid composition:
L-methionine and L-cysteine in a combined concentration of at least 61 mg/100 kcal, preferably in the range 90-110 mg/100 kcal, most preferably 100-110 mg/100 kcal.
L-tyrosine and L-phenylalanine in a combined concentration of at least 156 mg/100 kcal, preferably in the range 159-180 mg/100 kcal, most preferably 160-170 mg/100 kcal.
at least 40 mg/100 kcal, preferably 40-60 mg/100 kcal, more preferably 45-55 mg/100 kcal L-histidine
at least 90 mg/100 kcal, preferably 93-140 mg/100 kcal, more preferably 100-140 mg/100 kcal L-isoleucine
at least 166 mg/100 kcal, preferably 190-280 mg/100 kcal, more preferably 230-280 mg/100 kcal L-leucine
at least 113 mg/100 kcal, preferably 155-235 mg/100 kcal, more preferably 180-235 mg/100 kcal L-lysine
at least 77 mg/100 kcal, preferably 77-120 mg/100 kcal, more preferably 95-120 mg/100 kcal L-threonine
at least 32 mg/100 kcal, preferably 32-48 mg/100 kcal, more preferably 40-48 mg/100 kcal L-tryptophan
at least 88 mg/100 kcal, preferably 90-140 mg/100 kcal, more preferably 110-140 mg/100 kcal L-valine

In a preferred embodiment, the L-methionine content is at least 23 mg/100 kcal, more preferably at least 40 mg/100 kcal and the L-cysteine content is at least 38 mg/100 kcal, more preferably at least 50 mg/100 kcal.

In a further embodiment, the L-phenylalanine content is at least 81 mg/100 kcal, more preferably 81-90 mg/100 kcal, and the L-tyrosine content is at least 75 mg/100 kcal, more preferably 75-85 mg/100 kcal.

The whey protein: casein weight ratio in the SPC and the infant formula is preferably in the range in the range 60:40-90:10, preferably 65:35-85:15, most preferably 70:30-80:20.

The beta-casein content of the SPC is preferably in the range 0-25 wt %, more preferably 5-20 wt %, and most preferably 9-16 wt %. Beta-casein is rich in proline; proline is a precursor for the formation of polyamines, which are synthesized in the body with ornithine as intermediate.

The SPC preferably has the following amino acid content:
L-cysteine in the range 2.0-3.0 g/100 g protein, preferably 2.3-2.9 g/100 g protein
L-Histidine in the range 2.0-3.0 g/100 g protein, preferably 2.3-2.9 g/100 g protein
L-Isoleucine in the range 5.5-6.5 g/100 g protein, preferably 5.8-6.4 g/100 g protein
L-Leucine in the range 12.0-13.0 g/100 g protein, preferably 12.0-12.8 g/100 g protein
L-Lysine in the range 9.5-10.5 g/100 g protein, preferably 9.7-10.3 g/100 g protein
L-Methionine in the range 2.5-3.0 g/100 g protein, preferably 2.6-2.8 g/100 g protein
L-Phenylalanine in the range 4.3-4.7 g/100 g protein, preferably 4.4-4.6 g/100 g protein
L-Threonine in the range 5.0-5.5 g/100 g protein, preferably 5.0-5.4 g/100 g protein
L-Tyrosine in the range 4.1-4.5 g/100 g protein, preferably 4.1-4.3 g/100 g protein
L-Valine in the range 6.0-6.5 g/100 g protein, preferably 6.0-6.3 g/100 g protein
L-Tryptophan in the range 2.0-2.5 g/100 g protein, preferably 2.0-2.3 g/100 g protein

Such SPC can be prepared by microfiltration of (skimmed) milk-optionally diluted with water in a volume ratio water/milk of 0.5-1,5-using a 150-200 kDa microfiltration membrane and a temperature in the range 10-20° C., preferably 10-15° C., most preferably 10-12° C. This temperature enables beta-casein transmission through the membrane.

This microfiltration is followed by concentration of the serum-rich fraction with ultrafiltration using a 5-10 kDa membrane, also performed at a temperature in the range 10-20° C., preferably 10-15° C., most preferably 10-12° C. Ultrafiltration results in removal of water, lactose and minerals. The resulting UF retentate is the SPC.

In a preferred embodiment, these filtrations are performed using a total membrane surface—divided over several (e.g. 10-16) loops—in the range 5000-8000 m², preferably 5200-7500 m², more preferably 5400-7000 m², and most preferably 5400-6600 m² or 6200-7000 m², in order to adjust the protein fraction that permeates the membrane in such a way that a desired amino acid profile results.

Such large membrane surfaces allow for a more a constant, i.e. less fluctuating, operating pressure; this operating pressure being the pressure on the membranes.

This operating pressure preferably fluctuates in the range 0.8-3.5 bar, more preferably 0.2-3.0 bar, even more preferably 0.2-2.0 bar, even more preferably 0.2-1.0 bar, and most preferably 0.8-1.3 bar.

The feed flow rate is preferably in the range 16 to 19 m³/hr.

The flux over the membranes, i.e. the ratio between product flow and membrane surface, is preferably relatively low, more preferably in the range 2-30, preferably 2-10 l/m²/hr. This allows only the smallest casein molecules to pass the membrane, thereby obtaining a high whey protein-to-casein ratio.

The microfiltration is preferably combined with diafiltration, more preferably with a ratio between diafiltration flow and membrane surface in the range 2-30, preferably 2-10 l/m²/hr.

The cross flow over the membranes is preferably in the range of 50-300 m³/hr. The trans membrane pressure during microfiltration is preferably in the range 0-4.0 bar, more preferably 0.8-3.5 bar, and most preferably 0.8-1.3 bar.

The trans membrane pressure during ultrafiltration is preferably in the range 0-6.0 bar, more preferably 3.5-5.0 bar, and most preferably 3.5-4.0 bar.

Before said microfiltration, preferably between the optional skimming and said microfiltration, the milk may be subjected to a filtration step over a membrane capable of retaining bacteria and permeating milk proteins, for instance by applying filtration over a ceramic membrane, for instance a membrane with a pore size of around 1.4 μm pore size membrane.

A pasteurization step can be performed during the process. This pasteurization step is preferably performed before any filtration step and preferably after skimming of the milk. Alternatively, the SPC is pasteurized only after its preparation or after its incorporation in a nutritional composition.

All conventional types of microfiltration membranes—spiral wound, ceramic, hollow fibre, etc.—can be used. The membrane can be constructed form various polymer types, such as polysulfone (PS), (modified) polyethersulfone, polyvinylidene difluoride (PVDF), polyacrylonitrile (PAN), cellulose acetate (CA), and polypropylene (PP).

Preferred ultrafiltration membranes are spiral-wound membranes. Even more preferred are hydrophilic polyethersulfone (PES) membranes.

If so desired, the SPC may be further concentrated, demineralized and/or dried, for instance by nanofiltration, ion-exchange, electrodialysis, reverse osmosis, desalination, evaporation, and/or (spray) drying.

The total protein content is determined by the well-known Kjeldahl method (conversion factor 6.25).

The amino acid content of serum protein concentrate can be determined by ion exchange chromatography after hydrolyzation, according to ISO 13903:2005.

The protein composition can be determined via reverse phase HPLC, using a separation based on hydrophobicity and detection using UV.

The casein content of the SPC can be determined via precipitation at pH 4.6 using method of ISO 17997/DIF 29-1.

The formula milk according to the present invention can be prepared by combining the SPC with at least a lipid source, a carbohydrate source, vitamins, and minerals.

The lipid source may be any lipid or fat suitable for use in formula milk. Preferred fat sources include milk fat, safflower oil, egg yolk lipid, canola oil, olive oil, coconut oil, palm kernel oil, soybean oil, fish oil, palm oleic, high oleic sunflower oil and high oleic safflower oil, and microbial fermentation oil containing long-chain, polyunsaturated fatty acids. In one embodiment, anhydrous milk fat is used. The lipid source may also be in the form of fractions derived from these oils such as palm olein, medium chain triglycerides, and esters of fatty acids such as arachidonic acid, linoleic acid, palmitic acid, stearic acid, docosahexaeonic acid, linolenic acid, oleic acid, lauric acid, capric acid, caprylic acid, caproic acid, and the like. It may also be added small amounts of oils containing high quantities of preformed arachidonic acid and docosahexaenoic acid such as fish oils or microbial oils. The fat source preferably has a ratio of n-6 to n-3 fatty acids of about 5:1 to about 15:1; for example about 8:1 to about 10:1. In a specific aspect, the infant formula comprises an oil mix comprising palmitic acid esterified to triacylglycerols, for example wherein the palmitic acid esterified in the sn-2 position of triacylglycerol is in the amount of from 20% to 60% by weight of total palmitic acid and palmitic acid esterified in the sn-1/sn-3 position of triacylglycerol is in the amount of from 40% to 80% by weight of total palmitic acid.

Examples of vitamins and minerals that are preferably present in formula milk are vitamin A, vitamin B1, vitamin B2, vitamin B6, vitamin B12, vitamin E, vitamin K, vitamin C, vitamin D, folic acid, inositol, niacin, biotin, pantothenic acid, choline, calcium, phosphorous, iodine, iron, magnesium, copper, zinc, manganese, chloride, potassium, sodium, selenium, chromium, molybdenum, taurine, and L-carnitine.

### Minerals are Usually Added in Salt Form.

Examples of carbohydrates that are preferably present in formula milk are lactose, non-digestible oligosaccharides such as galacto-oligosaccharides (GOS), fructo-oligosaccharides (FOS), inulin, xylo-oligosaccharides, and human milk oligosaccharides (HMOs). Suitable HMOs include 2′-FL, 3-FL, 3′-GL, 3′-SL, 6′-SL, LNT, LNnT, and combinations thereof. HMO's are commercially available or can be isolated from milk in particular from human breast milk.

If necessary, the nutritional composition may contain emulsifiers and stabilisers such as soy lecithin, citric acid esters of mono- and di-glycerides, and the like. It may also contain other substances which may have a beneficial effect such as lactoferrin, nucleotides, nucleosides, probiotics, and the like.

Suitable probiotics include Lactobacteria, Bifidobacterium lactis such as Bifidobacterium lactis Bb12, Streptococcus thermophilus, Lactobacillus johnsonii La1, Bifidobacterium longum BL999, Lactobacillus rhamnosus LPR, L. rhamnosus GG, Lactobacillus reuteri, Lactobacillus salivarius. Such prebiotics are commercially available.

Formula milk is usually prepared for bottle-feeding or cup-feeding from powder (mixed with water) or liquid (with or without additional water).

Formula milk is generally available as a spray-dried powder. Spray-drying involves an additional heating step. In order to preserve as much of the native proteins as possible, it is desired to keep the heating conditions during spray-drying as mild as possible.

In order to reduce the number of processing steps that may denature any proteins, it is preferred to either dry blend the SPC with the other ingredients of the formula milk or mix liquid SPC with other liquid ingredients.

The formula milk according to the invention can be in the form of a dry, semi-dry or liquid composition. For example, it can be a powdered composition that is suitable for making a liquid composition after reconstitution with an aqueous solution, preferably with water.

In another embodiment, it is a liquid composition, for instance a ready-to-consume drinkable or spoonable composition.

### EXAMPLES

### Example 1

Skimmed milk was processed through ceramic membrane filtration at 50° C. and pasteurized at 72° C. for 15 seconds.

This skimmed milk was subsequently microfiltered and the microfiltration permeate was subsequently ultrafiltered, both at 15° C., using a total MF+UF membrane surface of 6200 m². The operating pressure fluctuated between 0.8 and 1.3 bar during microfiltration and between 3.5 and 4.0 bar during ultrafiltration.

The feed flow was 16.5 m³/hr during the complete run.

The resulting serum protein concentrate contained 65 wt % protein on dry solids.

The amino acid pattern of the resulting SPC was determined according to ISO 13903:2005; the results are displayed in Table 1.

This table also lists the amino acid content of an infant formula made with this SPC as the sole amino acid source and having a protein content of 1.9 g/100 kcal. These amino acid contents are all above the minimum amounts required by EU legislation.

TABLE 1

| | SPC | Infant formula |
|---|---|---|
| Amino acid | g/100 g protein | mg/100 kcal |
| Cystine | 2.8 | 58 |
| Histidine | 2.6 | 49 |
| Isoleucine | 5.9 | 112 |
| Leucine | 12.7 | 241 |
| Lysine | 9.9 | 188 |
| Methionine | 2.7 | 51 |
| Phenylalanine | 4.4 | 84 |
| Threonine | 5.0 | 95 |
| Tyrosine | 4.1 | 78 |
| Valine | 6.1 | 116 |
| Tryptophan | 2.1 | 40 |

### Comparative Example A

Example 1 was repeated, except that the total membrane surface was 4828 m². As a result, the operating pressure fluctuated much more: between 0.8 and 3.5 during microfiltration; between 3.5-5.2 during ultrafiltration.

The amino acid composition of the resulting SPC is presented in Table 2, which shows that especially the cysteine, leucine, lysine, threonine, and tryptophan contents of this SPC was significantly lower compared to Example 1, such that this SPC cannot be used as the sole amino acid source in infant formula, especially not in low protein infant formula.

TABLE 2

| | SPC |
|---|---|
| Amino acid | g/100 g protein |
| Cystine | 1.8 |
| Histidine | 2.7 |
| Isoleucine | 5.7 |
| Leucine | 10.7 |
| Lysine | 9.2 |
| Methionine | 2.6 |
| Phenylalanine | 4.5 |
| Threonine | 4.7 |
| Tyrosine | 4.5 |
| Valine | 6.1 |
| Tryptophan | 1.9 |

1. Serum protein concentrate having the following amino acid composition:
L-cysteine in the range 2.0-3.0 g/100 g protein, preferably 2.3-2.9 g/100 g protein
L-Histidine in the range 2.0-3.0 g/100 g protein, preferably 2.3-2.9 g/100 g protein
L-Isoleucine in the range 5.5-6.5 g/100 g protein, preferably 5.8-6.4 g/100 g protein
L-Leucine in the range 12.0-13.0 g/100 g protein, preferably 12.0-12.8 g/100 g protein
L-Lysine in the range 9.5-10.5 g/100 g protein, preferably 9.7-10.3 g/100 g protein
L-Methionine in the range 2.5-3.0 g/100 g protein, preferably 2.6-2.8 g/100 g protein
L-Phenylalanine in the range 4.3-4.7 g/100 g protein, preferably 4.4-4.6 g/100 g protein
L-Threonine in the range 5.0-5.5 g/100 g protein, preferably 5.0-5.4 g/100 g protein
L-Tyrosine in the range 4.1-4.5 g/100 g protein, preferably 4.1-4.3 g/100 g protein
L-Valine in the range 6.0-6.5 g/100 g protein, preferably 6.0-6.3 g/100 g protein
L-Tryptophan in the range 2.0-2.5 g/100 g protein, preferably 2.0-2.3 g/100 g protein.

2. A formula milk comprising Use of the serum protein concentrate of claim 1.

3. Process for producing the serum protein concentrate of claim 1, said process involving the step of microfiltration of milk using a 150-200 kDa membrane resulting in a casein-rich retentate and a serum-rich fraction as the permeate, followed by concentration of the serum-rich fraction by ultrafiltration using a 5-10 kDa membrane, said microfiltration and ultrafiltration being performed at a temperature in the range 10-20° C., preferably 10-15° C., most preferably 10-12° C.

4. Process according to claim 3 wherein said microfiltration and ultrafiltration are performed using a total membrane surface in the range of 5000-8000 m², preferably 5200-7500 m², more preferably 5400-7000 m², and most preferably 5400-6600 m² or 6200-7000 m².

5. Process according to claim 3 wherein the operating pressure during microfiltration fluctuates in the range 0.8-3.5 bar, preferably 0.8-3.0 bar, more preferably 0.8-2.5 bar, even more preferably 0.8-2.0 bar, more preferably 0.8-1.5 bar, and most preferably 0.8-1.3 bar.

6. Process according to claim 3 wherein the operating pressure during ultrafiltration fluctuates in the range 3.5-5.2 bar, preferably 3.5-5.0 bar, more preferably 3.5-4.5 bar, and most preferably 3.5-4.0 bar.

7. Process according to claim 3 wherein the flux over the membranes, i.e. the ratio between product flow and membrane surface, is in the range 2-30 l/m²/hr, preferably 2-10 l/m²/hr.

8. Process according to claim 3 wherein the trans membrane pressure during microfiltration is in the range 0-4.0 bar, preferably 0.8-3.5 bar, and most preferably 0.8-1.3 bar.

9. Process according to claim 3 wherein the trans membrane pressure during ultrafiltration is in the range 0-6.0 bar, preferably 3.5-5.0 bar, and most preferably 3.5-4.0 bar.

10. Method for producing formula milk requiring comprising introducing one or more amino acid sources, wherein at least one of the amino acid sources is the serum protein concentrate of claim 1 and wherein at least 90 wt %, preferably at least 95 wt %, more preferably at least 99 wt %, and most preferably 100 wt % of the total amino acid content in the formula milk results from the serum protein concentrate.

11. Method according to claim 10 wherein the formula milk has a protein content of at most 2.3 g protein/100 kcal, preferably at most 2.2 g protein/100 kcal, more preferably at most 2.1 g protein/100 kcal, even more preferably at most 2.0 g protein/100 kcal, more preferably at most 1.9 g protein/100 kcal.

12. Method according to claim 10 wherein the formula has the following amino acid composition:
L-methionine and L-cysteine in a combined concentration of at least 61 mg/100 kcal, preferably in the range 90-110 mg/100 kcal, most preferably 100-110 mg/100 kcal.
L-tyrosine and L-phenylalanine in a combined concentration of at least 156 mg/100 kcal, preferably in the range 159-180 mg/100 kcal, most preferably 160-170 mg/100 kcal.
at least 40 mg/100 kcal, preferably 40-60 mg/100 kcal, more preferably 45-55 mg/100 kcal L-histidine
at least 90 mg/100 kcal, preferably 93-140 mg/100 kcal, more preferably 100-140 mg/100 kcal L-isoleucine
at least 166 mg/100 kcal, preferably 190-280 mg/100 kcal, more preferably 230-280 mg/100 kcal L-leucine
at least 113 mg/100 kcal, preferably 155-235 mg/100 kcal, more preferably 180-235 mg/100 kcal L-lysine
at least 77 mg/100 kcal, preferably 77-120 mg/100 kcal, more preferably 95-120 mg/100 kcal L-threonine
at least 32 mg/100 kcal, preferably 32-48 mg/100 kcal, more preferably 40-48 mg/100 kcal L-tryptophan
at least 88 mg/100 kcal, preferably 90-140 mg/100 kcal, more preferably 110-140 mg/100 kcal L-valine

13. Method according to claim 12 wherein the formula milk has a L-methionine content of at least 23 mg/100 kcal, preferably at least 40 mg/100 kcal, and a L-cysteine content of at least 38 mg/100 kcal, preferably at least 50 mg/100 kcal.

14. Method according to claim 12 wherein, the L-phenylalanine content of the formula milk is at least 81 mg/100 kcal, preferably 81-90 mg/100 kcal, and the L-tyrosine content is at least 75 mg/100 kcal, preferably 75-85 mg/100 kcal.

15. Method according to claim 10 wherein the formula milk has a whey protein: casein weight ratio in the range 70:30-90:10, preferably 75:25-85:15, most preferably 77:23-83:17.
